(19) United States
(12) Patent Application Publication
(10) Pub. No.: US 2009/0132566 A1
(43) Pub. Date: May 21, 2009

(54) DOCUMENT PROCESSING DEVICE AND DOCUMENT PROCESSING METHOD

(76) Inventors: Shingo Ochi, Tokushima (JP); Takanori Hino, Tokushima (JP)

Correspondence Address: SUGHRUE MION, PLLC, 2100 PENNSYLVANIA AVENUE, N.W., SUITE 800, WASHINGTON, DC, 20037, US

(21) Appl. No.: 12/294,135

(22) PCT Filed: Mar. 28, 2007
(86) PCT No.: PCT/JP2007/056690

§ 371 Date: Sep. 23, 2008

(30) Foreign Application Priority Data
Mar. 31, 2006 (JP) 2006-099800

(51) Int. Cl. G06F 17/00; G06F 17/30

(52) U.S. Cl. 707/100; 715/234; 707/E17.009

(57) ABSTRACT

A structured document file in similarity relation is specified based on a tag structure of a structured document file.

A node-pair detection unit detects from a structured file a tag pair having a predetermined positional relation as a node pair. An attribute-value acquisition unit indexes as an attribute value the appearance mode of a node pair in a structured document file. An index-information creation unit creates index information associating a node pair and an attribute value thereof. A common-pair detection unit detects as a common pair a node pair that is common in a query document, which is a structured document file, and in a document to be examined, which is a structured document file to be compared. A node-similarity-value calculation unit indexes as a node similarity value, by referring to the index information of the query document and the index information of the document to be examined, the similarity between the attribute value of the common pair in the query document and the attribute value of the common pair in the document to be examined.

### TECHNICAL FIELD

The present invention relates to a document file retrieving technique.

With the growing use of computers and the progress of the networking techniques, there has been an increase in electronic information exchange via network. In this background, a lot of paperwork that is conventionally paper-based has been replaced by network-based processing. The progress of digitalization and network techniques has drastically lowered the cost for information acquisition. In this circumstance, the importance of a technique for retrieving a desired document file from a massive amount of document files has been rising.

[Patent document 1] JP 2006-048536

### DISCLOSURE OF THE INVENTION

### Problem to be Solved by the Invention

In recent years, a number of document files are created as structured document files called HTML (Hyper Text Markup Language) or XML (eXtensible Markup Language). Especially, XML has attracted attention as a format that is suitable for sharing data with other people via network. Although document creators can freely design tag structures of XML documents, the tag structures are often times patterned to some extent in accordance with the contents of documents. For example, in business documents, tag sets (vocabularies) that are used and the structures of the tags have a lot in common. However, tag sets that are used and the structures of the tags have less similarity in business documents and legal documents.

In this background, a general purpose of the present invention is to provide a technique for selecting structured document files having high relevance based on the tag structures of the structured document files.

### Means for Solving the Problem

An aspect of the present invention relates to a document processing apparatus. This apparatus detects as a node pair a pair of tags in a predetermined positional relation from a structured document file described in a predetermined tag set, indexes as an attribute value according to a predetermined rule an appearance mode of the node pair in the structured document file, and creates index information associating the node pair and its attribute value. The apparatus then detects as a common pair a common node pair in a group of node pairs detected from a first structured document file and in a group of node pairs detected from a second structured document file and indexes as a node similarity value, by referring to the index information of the first structured document file and the index information of the second structured document file, the similarity between the attribute value of the common pair in the first structured document file and the attribute value of the common pair in the second structured document file.

Optional combinations of the aforementioned constituting elements, and implementations of the invention in the form of methods, apparatuses, systems, recording mediums and computer programs may also be practiced as additional modes of the present invention.

### EFFECT OF THE INVENTION

The present invention can provide a technique for selecting structured document files having high relevance based on the tag structures of the structured document files.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram explaining the principle of an associative document retrieval based on a tag structure;

FIG. 2 is a schematic diagram explaining a parent-child relationship;

FIG. 3 is a schematic diagram explaining a repeating relationship;

FIG. 4 is a schematic diagram explaining a sibling relationship;

FIG. 5 is a functional block diagram of a document processing apparatus;

FIG. 6 is a screen view displaying the node similarity value;

FIG. 7 is a diagram showing the result of search on a given drug information database for node pairs; and

FIG. 8 is a table for obtaining the distribution approximate value.

### REFERENCE NUMERALS

100 document processing apparatus
110 user interface processor
120 data processor
130 data memory unit
132 input unit
134 document acquisition unit
136 display unit
140 index processor
142 node-pair detection unit
144 attribute-value acquisition unit
146 index-information creation unit
150 similarity determination unit
152 common-pair detection unit
154 node-similarity-value calculation unit
156 correction unit
158 rarity-value calculation unit
160 distribution-approximate-value acquisition unit
162 document-similarity-value calculation unit
170 document memory unit
172 index-information memory unit

### BEST MODE FOR CARRYING OUT THE INVENTION

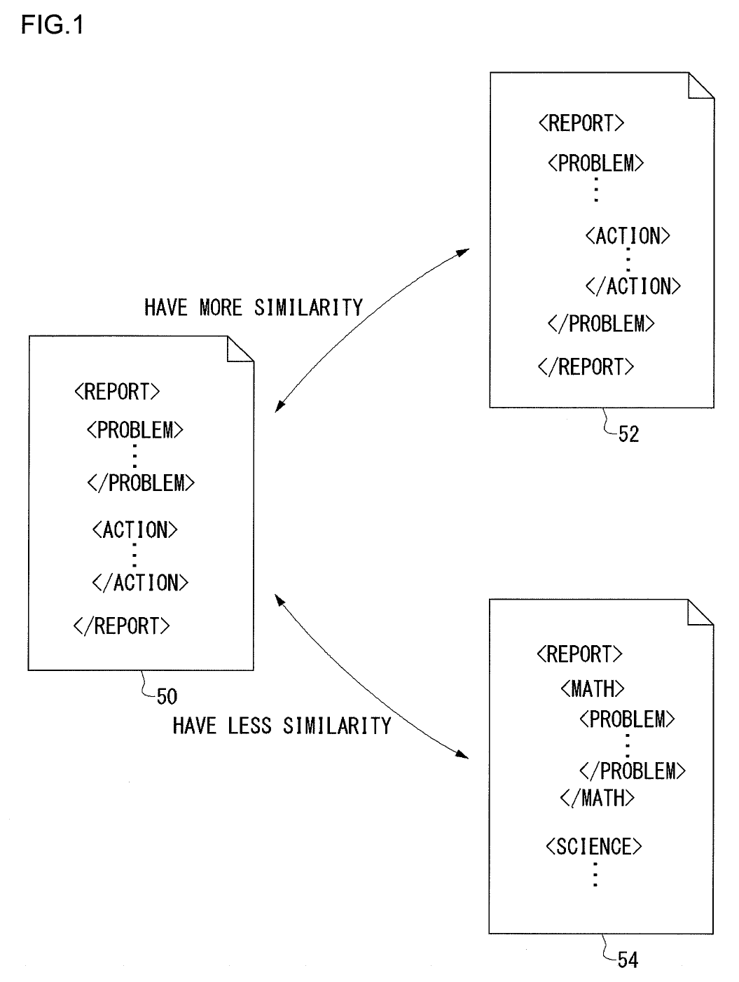

FIG. 1 is a schematic diagram explaining the principle of an associative document retrieval based on a tag structure.

FIG. 1 shows the instance of determining which structured document, a structured document 52 or a structured document 54, has a higher similarity to a structured document 50.

A structured document file, such as the structured document 50, against which similarity is examined is hereinafter referred to as a “query document”, and a structured document file that is compared and examined for similarity to a query document, such as the structured document 52 and the structure document 54, is hereinafter referred to as a “document to be examined”.

In the structured document 50 that is a query document, a <report> tag is higher in the hierarchy than a <problem> tag, and a <report> tag is higher in the hierarchy than an <action> tag.

Also in the structured document 52 that is a document to be examined, a <report> tag is higher in the hierarchy than a <problem> tag. Since the <problem> tag is higher in the hierarchy than the <action> tag, the <report> tag is considered to be higher in the hierarchy than the <action> tag, but only indirectly.

In the structured document 54 that is another document to be examined, a <report> tag is higher in the hierarchy than a <math> tag, and a <report> tag is higher in the hierarchy than a <science> tag.

Since a <math> tag is higher in the hierarchy than a <problem> tag, a <report> tag is higher in the hierarchy than a <problem> tag, but only indirectly.

When comparing the structured document 50 and the structured document 52, both documents are common in that a <report> tags is higher in the hierarchy than <problem> tags. On the other hand, although the structure document 54 also has a <report> tag and a <problem> tag that are hierarchized, a <math> tag located between the tags in hierarchy prevents the tags from having the direct hierarchy as in the structured document 50 and the structured document 52. The <report> tag is higher in the hierarchy than the <action> tag in the structured document 50, and the <report> tag is higher in the hierarchy than the <action> tag in the structured document 52 even though there is the <problem> tag between the tags. On the other hand, the structured document 54 does not even have the <action> tag. From this perspective, when comparing the tag structures of the structured document 50, the structured document 52, and the structured document 54, it is considered that the structured document 54 is structurally more similar to the structured document 50 than the structured document 52.

In searching for a document to be examined that has similarity relation with a query document, the following method is possible in general. The method is to compare a group of words included in the query document with a group of words included in the document to be examined and to determine that the more common words the document to be examined includes, the more similar the document to be examined is to the query document. In contrast, a method is suggested in the exemplary embodiment, a method to quantify the degree of similarity between a query document and a document to be examined based on the commonality in the tag structure in structured document files as shown in FIG. 1. Such a similar document search based on a tag structure is hereinafter referred to as a “structure similarity search” so as to distinguish it from a “content similarity search” that is a similar document search based on a group of words included in a document. For example, a document to be examined that is similar to a query document may be selected by performing the content similarity search after narrowing down a vast amount of documents to be examined using the similar structure search.

A document processing apparatus 100 in the exemplary embodiment detects a pair of the tags included in a structured document file and performs the structure similarity search having the pair (hereinafter, referred to as a “node pair”) as a base unit. A tag pair that can be detected as a node pair is required to have a predetermined positional relationship in a structured document file. Three relationships “parent-child”, “repeating”, and “sibling” are explained in the following as positional relationships in which a tag pair can be detected as a node pair.

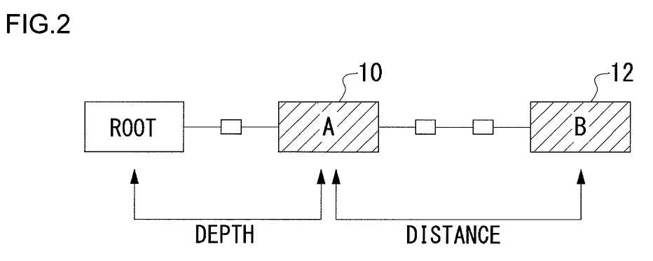

FIG. 2 is a schematic diagram explaining a parent-child relationship. The parent-child relationship indicates the state of two tags being in the hierarchy in a structured document file. In the figure, a B tag 12 lies lower than an A tag 10. In such a case, the A tag 10 and the B tag 12 are in the parent-child relationship. The parent-child relationship may be in the direct hierarchy, or it may be a relation having several tag levels between the A tag 10 and the B tag 12.

The appearance mode of a node pair in a structured document file is indexed as an attribute value. The attribute value is an index value regarding three items, “depth”, “distance”, and “frequency”. The attribute value hereinafter indicates a group of these three index values. The “depth” with regard to a node pair in the parent-child relationship indicates how many levels down in the hierarchy from the root tag the tag considered to be a parent is located. In the figure, since the A tag 10 is located two levels down from the root tag, the depth is “2”. The “distance” with regard to a node pair in the parent-child relationship indicates the number of levels from a parent tag to a child tag. In the figure, since the A tag 10 is located three levels apart from the B tag 12, the distance is “3”. In node pairs being in parent-child relationships, the number of the appearance of such combination of the A tag and the B tag having the depth “2” and the distance “3” in a structured document file is the “frequency”. The node pair in the parent-child relationship is hereinafter referred to as a “parent-child pair”.

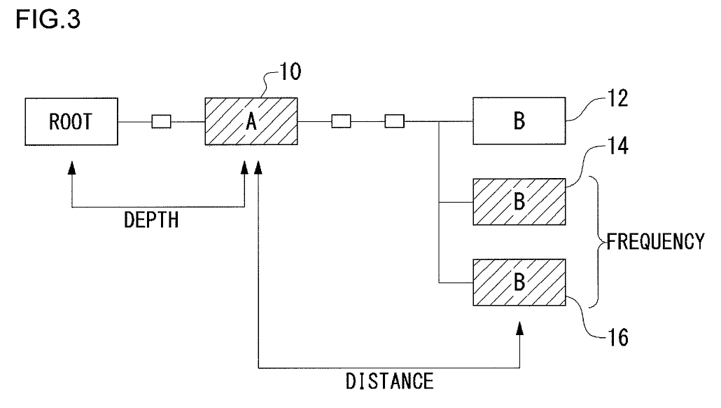

FIG. 3 is a schematic diagram explaining a repeating relationship. The repeating relationship is a relationship where child tags that have the same parent tag in common and have the same content appear multiple times. This can be considered as a special form of the parent-child relationship. In the figure, not only the A tag 10 and the B tag 12, but also the tags of a pair, the A tag 10 and the B tag 14, and a pair, the A tag 10 and the B tag 16, are in the parent-child relationship with the depth “2” and the distance “3”. In such a case, the first pair, the A tag 10 and the B tag 12, is in the parent-child relationship and a subsequent pair, the A tag 10 and the B tag 14, and another subsequent pair, the A tag 10 and the B tag 16, are considered to be in the repeating relationship. The A tag 10, the B tag 14, and the B tag 16 are in the repeating relationship with a frequency “2” and the frequency in the repeating relationship is always greater than or equal to 2. The depth and distance in the repeating relationship can be obtained as in the parent-child relationship. The node pair in the repeating relationship is hereinafter referred to as a “repeating pair”.

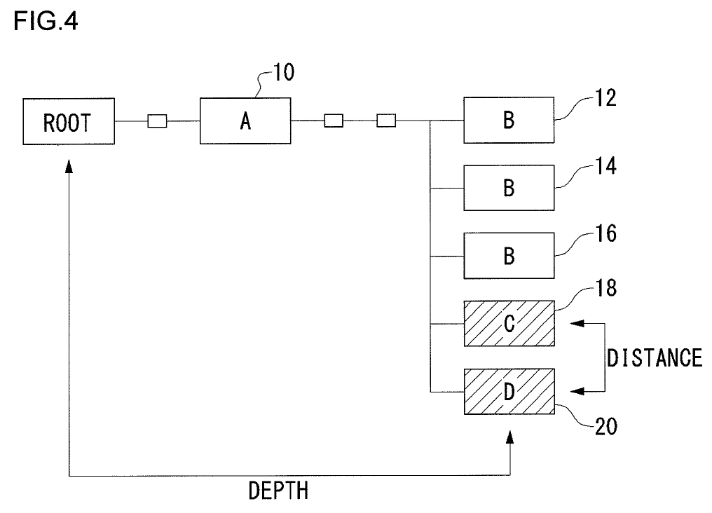

FIG. 4 is a schematic diagram explaining a sibling relationship. The sibling relationship is a relationship where a child tag, having a parent tag in common, which has different contents appear multiple times. In the figure, with regard to the A tag 10, three kinds of parent-child relationships are established: the A tag 10 and the B tag 12, the A tag 10 and a C tag 18, and the A tag 10 and a D tag 20. Also, the A tag 10, the B tag 14, and the B tag 16 are in the repeating relationship with a frequency “2”. In such a case, the B tag 16 and the C tag 18, the B tag 16 and the D tag 20, and the C tag 18 and the D tag 20 are in the sibling relationship. The distance of the node pair in the sibling relationship (hereinafter, referred to as a “sibling pair”) can be obtained as a distance between one tag and the other tag in the same level. In the figure, the distance between the B tag 16 and the C tag 18 is “1”, the distance between the B tag 16 and the D tag 20 is “2”, and the distance between the C tag 18 and the D tag 20 is “1”. Although there are three B tags, the B tag 16 is selected for convenience to obtain the distance between a sibling pair since it has the shortest distance. In addition, in the figure, when a sibling pair has one B tag, the average of the distances between the pair having the B tag 12, the pair having the B tag 14, and the pair having the B tag 16 may be obtained as the distance between a sibling pair having a B tag. For example, in the case of the C tag 18, the distance of the sibling pair having the C tag 18 and a B tag may be obtained to be 2 from the calculation: (1+2+3)/3=2. The “depth” in a sibling pair indicates the number of levels from a root tag. In the figure, the depth of the sibling pairs is “5”.

In a structured document, a tag pair that represents any of a parent-child pair, a repeating pair, and a sibling pair is subject to be detected as a node pair. Since the relationships shown in FIGS. 2-4 are the examples of defining node pairs characterizing a tag structure of a structured document file, a user of the document processing apparatus 100 may arbitrarily determine how a node pair is defined depending on the positional relationship of a tag pair. An explanation is now given mainly as to the simplest parent-child relationship in the exemplary embodiment.

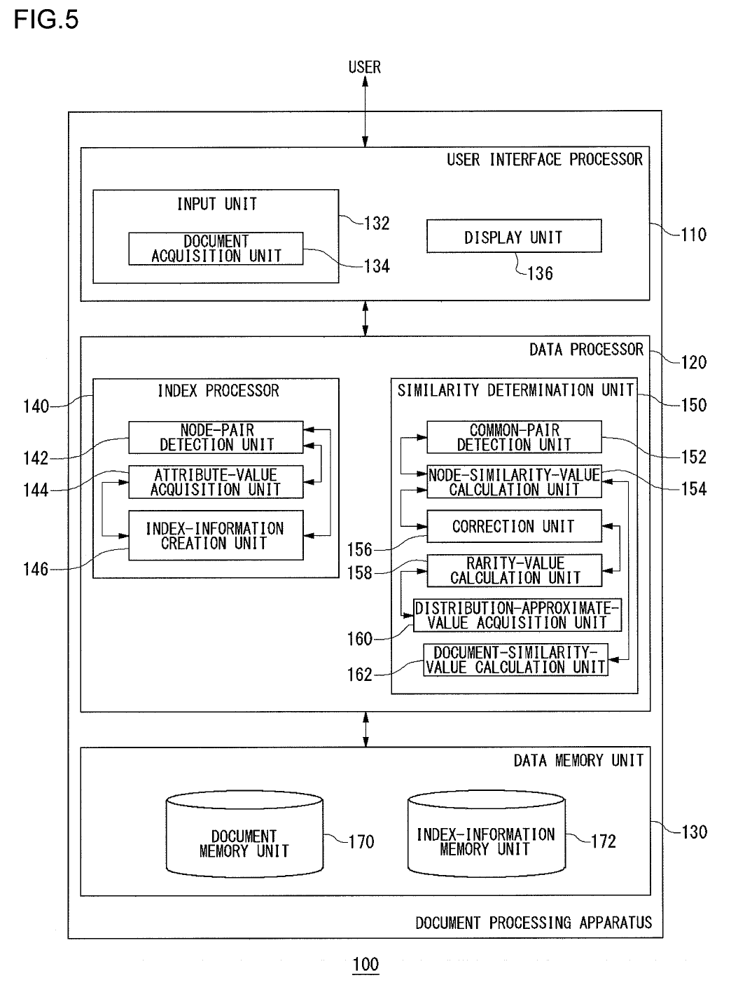

FIG. 5 is a functional block diagram of a document processing apparatus 100. The blocks shown are implemented in hardware by any CPU of a computer, other elements, and mechanical devices, and in software by a computer program or the like. FIG. 5 depicts functional blocks implemented by the cooperation of hardware and software. Therefore, it will be obvious to those skilled in the art that the functional blocks may be implemented in a variety of manners by a combination of hardware and software.

The document processing apparatus 100 is provided with a user interface processor 110, a data processor 120, and a data memory unit 130. The user interface processor 110 is in charge of the process with regard to a general user interface such as processing the input from a user and displaying information to a user. In the exemplary embodiment, an explanation is given on the premise that the user interface service of the document processing apparatus 100 is provided by the user interface processor 110. As another example, the user may manipulate the document processing apparatus 100 via internet. In this case, a communication unit (not shown) receives manipulation-instruction information from a user terminal and transmits information on the results of the process performed based on the manipulation instruction.

The data processing processor 120 performs various data process based on the data acquired from the user interface processor 110. The data processor 120 also plays a role of an interface between the user interface processor 110 and the data memory unit 130. The data memory unit 130 stores various data such as setting data provided in advance or data received form the data processor 120.

The user interface processor 110 is provided with an input unit 132 and a display unit 136. The input unit 132 receives input manipulation from a user. The display unit 136 displays all sorts of information to the user. The input unit 132 includes a document acquisition unit 134 for obtaining a structured document file from outside sources.

The data memory unit 130 is provided with a document memory unit 170 and an index-information memory unit 172. The document memory unit 170 retains the structured document file acquired from the document acquisition unit 134. The index-information memory unit 172 retains index information created by an index-information creation unit 146, which will be described later.

The data processor 120 includes an index processor 140 and a similarity determination unit 150. The index processor 140 creates index information associated with a node pair and its attribute value for every structured document file. The index processor 140 includes a node-pair detection unit 142, an attribute-value acquisition unit 144, and an index-information creation unit 146. When the document acquisition unit 134 acquires a structured document file, the node-pair detection unit 142 detects a node pair from the structured document file. The attribute-value acquisition unit 144 calculates attribute values for the depth, the distance, and the frequency for every detected node pair. The index-information creation unit 146 creates index information associating a document ID for specifying a structured document file, a node pair, and its attribute value and records the index information in the index-information memory unit 172.

The similarity determination unit 150 performs structure similarity search by comparing index information of a query document with index information of a document to be examined. The similarity determination unit 150 includes a common-pair detection unit 152, a node-similarity-value calculation unit 154, a correction unit 156, a rarity-value calculation unit 158, a distribution-approximate-value acquisition unit 160, and a document-similarity-value calculation unit 162.

The common-pair detection unit 152 detects a node pair that is included in both a node pair group included in a query document and a node pair group included in a document to be examined. Such a node pair is hereinafter referred to as a “common pair”. For example, when there is a parent-child pair of a tag <A> and a tag <B> in a query document and there is also a parent-child pair of a tag <A> and a tag <B> in a document to be examined, the pair of the tag <A> and the tag <B> are detected as a common pair for both the query document and the document to be examined even when their attribute values are different.

The names of the tags do not need to match perfectly with each other. For example, it is assumed that a <report> tag and a <date> tag constitute a parent-child pair in a query document and a <rep> tag and a <date> tag have a parent-child relationship in a document to be examined.

Since the tag having a name <report> and the tag having a name <rep> have three letters “rep” in common, the tags have a similarity to some extent with respect to their names. In this case, a node pair including the <report> tag and the <date> tag is handled as a common pair. As described above, when two tags subject to comparison have more than a predetermined number of letters in common, or when the name of one tag includes the name of the other tag, it may be determined that the tags are in a similarity relation. Synonyms dictionary data that defines the similarity relation between words may be prepared in advance so that the common-pair detection unit 152 determines whether two tags subject to comparison are in a similarity relation. In XML, the document creator can arbitrary set a tag name. Thus, often times the tag name of the query document and the tag name of the document to be examined do not match perfectly but have similar names. Detecting a common pair in consideration of the similarity relation of the tag name can achieve a more practical structure-similarity search in structured document files such as XML documents.

A node-similarity-value calculation unit 154 calculates as a node similarity value the degree of similarity in the attribution values of common pairs in the query document and the document to be examined. A formula for the calculation will follow. The node similarity value is calculated for all the common pairs from the node pair group of the query document.

A rarity-value calculation unit 158 calculates a rarity value for each common pair. The rarity value is a numeric value indicating the frequency of the appearance of a common pair to be examined from a group of structured document files (hereinafter, simply referred to as “corpus”) included in the document memory unit 170. The smaller the number of the appearance of a node pair is in a corpus, the larger the rarity value becomes.

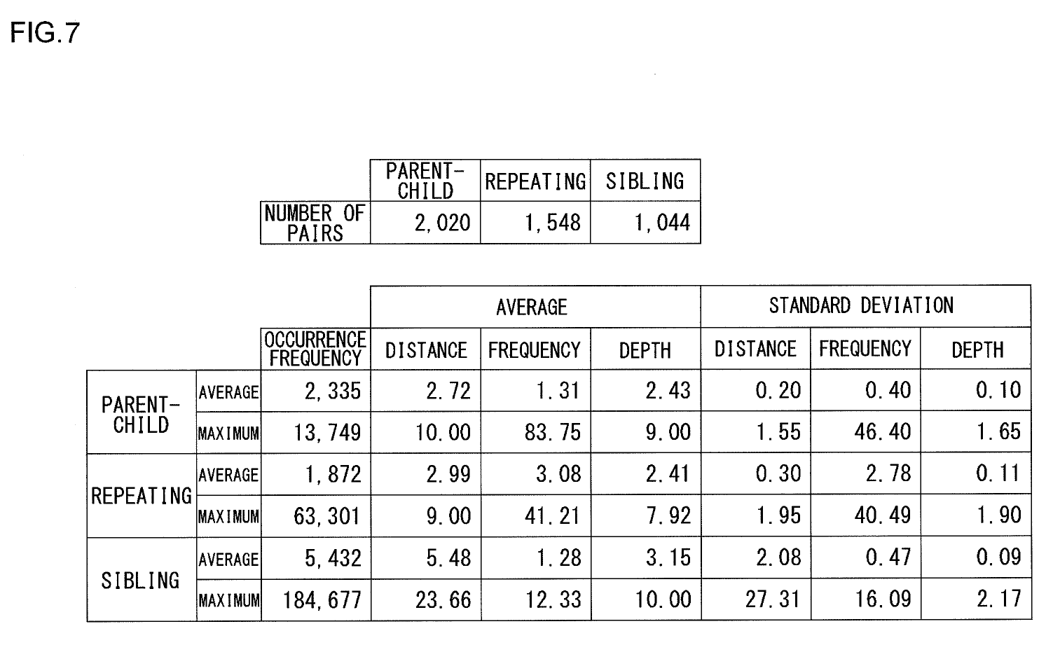

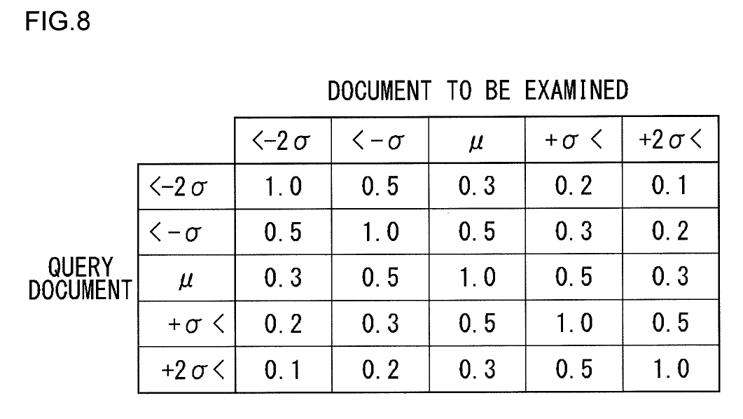

A distribution-approximate-value acquisition unit 160 calculates a distribution approximate value for each common pair. The attribute value of a node pair identified as a common pair varies in a corpus. For example, a parent-child pair may appear having a distance “3” in a structured document and it may appear having a distance “8” in another structured document. On the other hand, the distance of another parent-child pair may vary in the range of “3-5” in the corpus. The distribution approximate value is an index value for correcting the node similarity value in consideration of such variation of the attribute value of a common pair. The distribution approximate value will be described in detail in association with FIGS. 7 and 8. The correction unit 156 corrects the node similarity value based on the rarity value and the distribution approximate value. A detailed description will also be given regarding a specific correction method.

A document-similarity-value calculation unit 162 calculates as a document similarity value the degree of similarity in tag structure between a query document and a document to be examined from the node similarity value of each common pair detected in consideration of the relation between the query document and the document to be examined. For example, when multiple common pairs are included in the query document and the document to be examined, the total value or average value for these common pairs may be calculated as a document similarity value. In the exemplary embodiment, the total value of the node similarity value is calculated as the document similarity value. The more common pair there is and the larger the node similarity value is, the larger the document similarity value becomes. The document similarity value is a numeric value indexing the similarity in tag structure between a query document and a document to be examined. The distribution approximate value will be described in detail in association with FIG. 7 and subsequent figures. First, a calculation formula for the node similarity value is shown including the correction based on a rarity value.

$$\begin{matrix}[ Calculation 1 ] & \\ RARITY VALUE = 1.0 + log ( \frac{documentCount}{distribution} ) & ( 1 ) \\ Difference = \sqrt{\begin{matrix}\begin{matrix}α \times {( \frac{qDistance - dDistance}{maxDistance} )}^{2} + \\ β \times {( \frac{qFrequency - dFrequency}{maxFrequency} )}^{2}\end{matrix} \\ γ \times {( \frac{qDepth - dDepth}{maxDepth} )}^{2}\end{matrix} +} & ( 2 ) \\ {NODE SIMILARITY VALUE}_{( AFTER THE CORRECTION )} = I D F \times ( 1.0 - Difference ) & ( 3 )\end{matrix}$$

The formulas (1) through (3) are the formulas for the calculation of the node similarity value for a node pair C that becomes both a parent-child pair and a common pair in a given query document A and a document to be examined.

The formula (1) is a formula for calculating the rarity value of the node pair C. In the formula (1), a “documentCount” represents the number of structured document files stored in the document memory unit 170. In other words, it is the number of documents included in a corpus. The rarity value may be calculated for a document group included not in the document memory unit 170 but in a predetermined external database. In the formula (1), a “distribution” represents the total number of appearance of the node pair C in the corpus. In a corpus, the smaller the number of appearance by comparison with the number of documents is, the larger the rarity value becomes. The rarity-value calculation unit 158 calculates the rarity value using the calculation formula shown as the formula (1).

The formula (2) is a calculation formula for indexing as a “Difference” value the difference in attribute value of a node pair C between a query document and a document to be examined. For example, when the distance of the node pair C in the query document is 3 and the distance of the node pair C in the document to be examined is 10, although the node pair C is a common pair, its appearance mode varies a great deal between the two documents. In this case, the “difference” value becomes larger.

A “qDistance” of the formula (2) represents an attribute value for the distance of the node pair C in the query document. The “dDistance” is an attribute value for the distance of the node pair C in the document to be examined. When there are multiple node pairs C in the document to be examined, the “dDistance” represents the average distance. A “maxDistance” shows the maximum distance of the node pair C in the corpus. When the maximum distance exceeds a predetermined value, for example, “10”, the maximum distance is set to “10” across the board.

Similarly, a “qFrequency” shows a “frequency” of the node pair C in a corpus, a “dFrequency” shows a “frequency” of the node pair C in a document to be examined, and a “max Frequency” shows a maximum frequency of a node pair in a corpus. The upper limit of the maximum frequency is also set to “10” as a predetermined value. A “qDepth” shows a “depth” of the node pair C in a query document, a “dDepth” shows a “depth” of the node pair C in a document to be examined, and a “maxDepth” shows a maximum depth of a node pair C in a corpus. The upper limit of the maximum depth is also set to “10” as a predetermined value.

The first term in the square root of the formula (2) is the term that indexes the difference in distance between the node pairs C in the query document and the document to be examined. Similarly, the second term is the term that indexes the difference in frequency, and the third term is the term that indexes the difference in depth. The smaller the differences in three elements, distance, frequency, and depth, which are calculated in the first term through the third term are, the smaller the “Difference” value becomes.

The α, β, and γ are weighting coefficients for each element of distance, frequency, and depth. The difference in distance between parent-child pair rather than the difference in frequency or the difference in depth is considered to contribute more to the difference in the tag structure. Also, the difference in depth rather than the difference in distance or the difference in frequency is considered to contribute less to the tag structure. Thus, α is set to 0.7, β is set to 0.2, and γ is set to 0.1 in the exemplary embodiment so that α>β≧γ is satisfied. On the precondition that the sum of the α, β, and γ is 1, the optimal values for α, β, and γ may be obtained from the experiment according to the corpus. The node-similarity-value calculation unit 154 obtains the Difference value from the formula (2) and calculates the node similarity value such that node similarity value=(1.0-Difference value).

The formula (3) is a calculation formula for correcting the node similarity value obtained from the formula (2) using the rarity value obtained form the formula (1). The correction unit 156 corrects the node similarity value by multiplying the rarity value by the node similarity value. This node similarity value after the correction shows the degree of similarity between the appearance mode of the node pair C in the query document and the appearance mode of the node pair C in the document to be examined. When a rare node pair appears as a common pair in the two documents to be compared, the node similarity value becomes large. Such a node pair can be considered to be an important node pair that shows the similarity in tag structure between the query document and the document to be examined. This is an application of the idea of a TF (Term Frequency)-IDF (Inverse Document Frequency) method. On the other hand, since a node pair that appears often in a corpus does not particularly suggest any similarity between two documents to be compared, the node similarity value is corrected to be a small value.

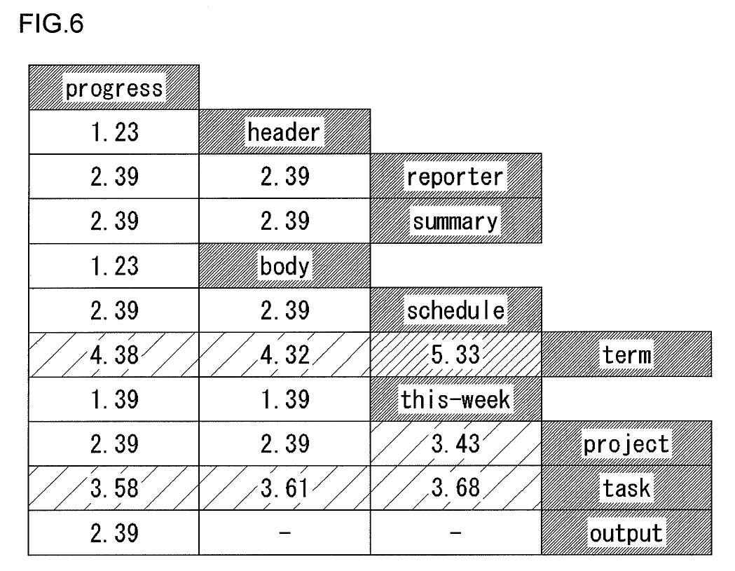

FIG. 6 is a screen view displaying the node similarity value. Upon the specification of a query document and a document to be examined, the display unit 136 arranges multiple display regions (hereinafter, referred to as a “pair box”) in correspondence to a parent-child pair in the query document and displays the node similarity value in each pair box. The figure is a display screen corresponding to the tag structure of the following query document.

```
<progress>
    <header>
        <reporter></reporter>
        <summary></summary>
    </header>
    <body>
        <schedule>
            <term></term>
        </schedule>
        <this-week>
            <project></project>
            <task></task>
            <output></output>
        </this-week>
    </body>
</project>
```

When the document acquisition unit 134 acquires the query document, the node-pair detection unit 142 scans the tag structure of the query document and detects a total of 22 parent-child pairs. The attribute-value acquisition unit 144 detects the attribute values for the distance, the frequency, and the depth for each parent-child pair. The index-information creation unit 146 creates the index information and records the index information in the index-information memory unit 172. The query document is stored in the document memory unit 170.

The common-pair detection unit 152 selects a document to be examined sequentially from the document memory unit 170. Alternatively, the user may explicitly specify via the input unit 132 the document to be examined that is subject to comparison. The common-pair detection unit 152 detects a common pair by referring to the index information of the query document and the index information of the document to be examined. The parent-child pairs of <body> and <output> and of <this-week> and <output> are not detected from the document to be examined; however, other parent-child pairs are detected. In other words, excluding these two pairs, 20 parent-child pairs out of the 22 parent-child pairs in the query document are common pairs. The node-similarity-value calculation unit 154 calculates the node similarity value for these 20 common pairs, and the correction unit 156 corrects each node similarity value based on a rarity value. The display unit 136 displays the node similarity value in the pair box for each parent-child pair in the query document.

In the 20 common pairs, a common pair having a <schedule> tag and a <term> tag takes the maximum node similarity value 5.33. Comparing the query document and the document to be examined, the appearance mode of this common pair is found to be prominently similar. The display unit 136 displays a pair box of a common pair having a node similarity value of at least a predetermined value, for example, 5.0, using a different color from that of pair boxes of other common pairs. For example, the pair box is displayed in dark red.

Also, the node similarity value of the common pair having a <progress> tag and a <term> tag is 4.32, and the node similarity value of the common pair having a <body> tag and a <term> tag is 4.38. Although not so much as the common pair having a <schedule> tag and a <term> tag, these common pairs are the node pairs that are similar in appearance mode. The display unit 136 displays the pair boxes having the node similarity values of at least 4.00 in light red. Also, the pair boxes having the node similarity values of less than 4.00 are displayed in white. Such a display method allows a node pair particularly similar in appearance mode to be easily specified visually when comparing a query document and a document to be examined.

The document-similarity-value calculation unit 162 calculates the total value of the node similarity value as the document similarity value. The similarity determination unit 150 performs structure similarity search by calculating the document similarity value of the document to be examined with respect to the query document. For example, a predetermined number of documents to be examined are selected in decreasing order of the document similarity value as structured documents that are similar to the query document. The display unit 136 may further include a ranking display unit that is not shown. The ranking display unit selects a predetermined number, for example, 20, of the documents to be examined in descending order of the document similarity value calculated with respect to a given query document and displays a ranking of the titles in a list format. Alternatively, the unit displays a ranking of the documents to be examined having the document similarity values of a predetermined value, for example, at least 80, in descending order of the document similarity value. Such a display method allows easier comprehensive recognition of the document to be examined whose tag structure is similar to the query document.

Also, the idea of such structure similarity search permits ambiguous search using an Xpath formula. For example, when using an Xpath formula “/body/note/chapter/para” as a search formula and searching for the corresponding position in the document to be examined, no tag having a position “/body/a/note/chapter/para” is identified in the regular Xpath search. This is due to the reason that a tag “a” that does not meet the condition is included. However, searching for the node similarity value for a node pair “body/note” or “note/chapter” permits the Xpath search for close to a perfect match if not a perfect match for the search formula.

FIG. 7 is a diagram showing the result of the search on node pairs in a given drug information database. The structured document that is searched on is an XML document and the number of documents is 11682 and the total size is about 400 megabytes. In this database, 2020 kinds of parent-child pairs, 1548 kinds of repeating pairs, and 1044 kinds of sibling pairs have been detected. In the 2020 kinds of parent-child pairs, the most frequently appeared parent-child pair has appeared 13749 times. Also, the average number of one parent-child pair to appear in a document group is 2335. In the 2020 kinds of parent-child pairs, the maximum distance is 10 and the average distance is 2.72. It is to be noted, however, that the upper limit of the distance of a parent-child pair is set to 10. Similarly, the maximum frequency is 83.75, the average frequency is 1.31, the maximum depth is 9.00, and the average depth is 2.43 in the parent-child pairs.

The maximum value of a standard deviation that shows the variation in distance is 1.55 and an average standard deviation is 0.20. In other words, the distance of a given parent-child pair varies around the standard deviation of 1.55; however, the average variation in distance of the parent-child pairs is around the standard deviation of 0.20. Thus, it is found that the distances of the parent-child pairs do not vary so much. With respect to the variation in frequency, a maximum standard deviation is 46.40, and an average standard deviation is 0.40. Thus, the frequency is found to vary widely. Also, with respect to the variation in depth, a maximum standard deviation is 1.65, and an average standard deviation is 0.10. The results shown in the same figure are obtained for the repeating pairs and the sibling pairs.

As described above, the variation in the attribute value varies for every node pair type (e.g., a parent-child pair and a sibling pair) and further for every node pair. The distribution-approximate-value acquisition unit 160 calculates, in consideration of the variation in the attribute value of a node pair, the distribution approximate value as a variable for correcting the node similarity value. When the variation in attribute value of a given node pair A follows the normal distribution, about 68% of the node pair A's detected in the corpus fall in the range of the average attribute value μ± the standard deviation σ. Also, about 95% fall in the range of μ±2σ.

For example, it is assumed that with respect to a common pair C detected from a query document A and a document B to be examined, the distance of the common pair C in the query document A takes a value of μ−2.5σ. On the other hand, the distance of the common pair C in the document B to be examined is a value of μ+1.8σ. Although the common pair C appears both in the query document A and the document B to be examined, its statistical position differs greatly. In this case, the distribution approximate value becomes smaller and the node similarity value is corrected to be smaller.

FIG. 8 is a table for obtaining the distribution approximate value. For example, when the distance of a given node pair A is greater or equal to μ but less than μ+σ, and when the distance of a given node pair A in a document to be examined is also greater or equal to μ but less than μ+σ, the distribution approximate value for the distance of the node pair A is 1.0. As described above, when the attribute value of a common pair in a query document and the attribute value of the common pair in a document to be examined are in a statistically close relationship, the distribution approximate value is 1.0. On the other hand, when the difference between the position of the attribute value of a common pair in a query document and the position of the attribute value of the common pair in a document to be examined is greater or equal to σ but less than 2σ, the distribution approximate value is 0.5. Similarly, when the difference is greater or equal to 2σ but less than 3σ, the distribution approximate value is 0.3; when the difference is greater or equal to 3σ but less than 4σ, the distribution approximate value is 0.2; and when the difference is greater or equal to 4σ, the distribution approximate value is 0.1.

The correction unit 156 corrects the node similarity value by multiplying the formula (3) by the distribution approximate value. For example, by multiplying the node similarity value of formula (3) after the correction by the respective distribution approximate value for the distance, the frequency, and the depth, the final node similarity value may be obtained in consideration of the standard deviation. Such a processing method permits the node similarity value to be largely controlled when the attribute values of common pairs in the query document and the document to be examined are in a statistically distant relationship.

Alternatively, by dividing (qDistance-dDistance) of the formula (3) by the distribution approximate value for the distance, the part may be changed to qDistance-dDistance/(distribution approximate value for the distance). The same applies to the frequency and the depth. Such a processing method permits the node similarity value to be smaller since when there is an attribute value having a statistically distant relationship, the Difference value becomes larger.

Not to mention that the setting of the distribution approximate value shown in FIG. 8 is only an example, the suitable setting of the distribution approximate value may be obtained in accordance with the corpus.

Described above is the explanation of the present invention based on the exemplary embodiments. The document processing apparatus 100 can compare the tag structure of a query document with the tag structure of a document to be examined and quantify as the node similarity value and the document similarity value the similarity in structure having a node pair as a unit. Since the structure similarity search can be achieved using a simple algorithm, a high-speed search can be achieved.

Setting simple elements, the distance, the frequency, and the depth, as attribute values of a node pair, the process for acquiring the attribute value is simplified. Also, a node pair that is distinctive in a corpus is corrected using a rarity value so that the node similarity value becomes larger. Therefore, a search can be achieved in consideration of a node pair that is useful and of a node pair that is not useful in determining the similarity between a query document and a document to be examined. Also, the node similarity value is corrected in consideration of the variation of each node pair and also the variation of each attribute value. Therefore, even though a common pair is detected, the node similarity value is small when the common pair includes an attribute value in a statistically distant relationship. Thus, the accuracy of the structure similarity search can be further improved. Also, a more practical structure similarity search can be achieved by considering the similarity of a tag name.

Described above is the explanation of the present invention based on the embodiments. These embodiments are intended to be illustrative only and it will be obvious to those skilled in the art that various modifications to constituting elements and processes could be developed and that such modifications are also within the scope of the present invention.

The function of a rarity-based correction unit described in claims can be achieved by the node-similarity-value calculation unit 154 and the correction unit 156 in the exemplary embodiment. Also, the function of a distribution-based correction unit described in claims can be achieved by the node-similarity-value calculation unit 154 and the correction unit 156 in the exemplary embodiment. The function of a node-similarity-value display unit described in claims can be achieved by the display unit 136 in the exemplary embodiment.

Therefore, it will be obvious to those skilled in the art that the function to be achieved by each constituent requirement described in the claims may be achieved by each functional block shown in the exemplary embodiments or by a combination of the functional blocks.

### INDUSTRIAL APPLICABILITY

The present inventions can be used for a search device targeting a structured document file.

What is claimed is:

1. A document processing apparatus comprising:
a node-pair detection unit operative to detect from a structured file described using a predetermined tag set a tag pair having a predetermined positional relation as a node pair;
an attribute-value acquisition unit operative to index as an attribute value according to a predetermined rule an appearance mode of a node pair in a structured document file;
an index creation unit operative to create index information associating a node pair and an attribute value thereof;
a common-pair detection unit operative to detect as a common pair a node pair that is common in a node pair group detected from a first structured document file and a node pair group detected from a second structured document file; and
a node-similarity-value calculation unit operative to index as a node similarity value, by referring to the index information of the first structured document file and the index information of the second structured document file, the similarity between the attribute value of the common pair in the first structured document file and the attribute value of the common pair in the second structured document file.

2. The document processing apparatus according to claim 1, wherein the attribute-value acquisition unit is operative to index as attribute values a relative positional relation of two tags included in a node pair, a position of a tag included in a node pair in a structured document file, or the number of the appearance of a node pair in a structured document file.

3. The document processing apparatus according to claim 1, further comprising a document-similarity-value calculation unit operative to calculate as a document similarity value, from a node similarity value calculated for a common pair in a first structured document file and a second structured document file, the similarity in a document structure between the first structured document file and the second structured document file.

4. The document processing apparatus according to claim 3, further comprising a ranking display unit operative to display, when a document similarity value to a first structured document file to be compared against is calculated for each of a plurality of second document files, a list of titles of the second structured document files in descending order of the document similarity value.

5. The document processing apparatus according to claim 1, wherein the common-pair detection unit is operative to determine according to a predetermined evaluation rule whether a character string showing a tag name included in a node pair detected from a first structured document file and a character string showing a tag name included in a node pair detected from a second structured document file are in a similarity relation and to target, and, when the character strings are determined to be in the similarity relation, identify those node pairs as common pairs.

6. The document processing apparatus according to claim 1, further comprising:
a rarity-value calculation unit operative to calculate as a rarity value, by counting the occurrence frequency of a node pair to be examined from a plurality of targeted structured document files, the rarity of an appearance of the node pair in the plurality of structured document files; and
a rarity-based correction unit operative to correct a node similarity value in accordance with a rarity value so that a node similarity value of a common pair having a high rarity value is increased.

7. The document processing apparatus according to claim 1, further comprising:
a distribution-approximate-value calculation unit operative to specify a statistical distribution range of an attribute value of a node pair to be examined from a plurality of targeted structured document files and to calculate as a distribution approximate value the closeness of the position of an attribute value in the distribution range of a common pair in a first structured document file and the position of an attribute value in the distribution range of a common pair in a second structured document file; and
a distribution-based correction unit operative to correct a node similarity value in accordance with a distribution approximate value so that a node similarity value of a common pair close to the other common pair in the distribution range is increased.

8. The document processing apparatus according to claim 1, further comprising a node-similarity-value display unit operative to arrange on a screen a plurality of display regions corresponding to a node pair detected from a first structured document file and to change a display mode of a display area corresponding to a common pair in accordance with a node similarity value for a common pair detected in consideration of the relation with a second structured document file.

9. A document processing method comprising:
detecting in a structured file described using a predetermined tag set a tag pair having a predetermined positional relation as a node pair;
indexing as an attribute value according to a predetermined rule an appearance mode of a node pair in a structured document file;
creating index information associating a node pair and an attribute value thereof;
detecting as a common pair a node pair that is common in a node pair group detected from a first structured document file and a node pair group detected from a second structured document file; and
indexing as a node similarity value, by referring to the index information of the first structured document file and the index information of the second structured document file, the similarity between the attribute value of the common pair in the first structured document file and the attribute value of the common pair in the second structured document file.

10. A document processing computer program product comprising:
a module that detects from a structured file described using a predetermined tag set a tag pair having a predetermined positional relation as a node pair;
a module that indexes as an attribute value according to a predetermined rule an appearance mode of a node pair in a structured document file;
a module that creates index information associating a node pair and an attribute value thereof;
a module that detects as a common pair a node pair that is common in a node pair group detected from a first structured document file and a node pair group detected from a second structured document file; and
a module that indexes as a node similarity value, by referring to the index information of the first structured document file and the index information of the second structured document file, the similarity between the attribute value of the common pair in the first structured document file and the attribute value of the common pair in the second structured document file.
